(19) United States
(12) Patent Application Publication
(10) Pub. No.: US 2004/0219329 A1
(43) Pub. Date: Nov. 4, 2004

(54) Perpendicular magnetic recording medium and magnetic recording/reproducing apparatus

(75) Inventors: Soichi Oikawa, Chiba-shi (JP); Takeshi Iwasaki, Funabashi-shi (JP); Hiroshi Sakai, Ichihara-shi (JP); Akira Sakawaki, Ichihara-shi (JP); Kenji Shimizu, Ichihara-shi (JP)

Correspondence Address: PILLSBURY WINTHROP, LLP, P.O. BOX 10500, MCLEAN, VA, 22102, US

(73) Assignees: KABUSHIKI KAISHA TOSHIBA, Tokyo (JP); SHOWA DENKO K.K., Tokyo (JP)

(21) Appl. No.: 10/791,277

(22) Filed: Mar. 3, 2004

(30) Foreign Application Priority Data
Mar. 31, 2003 (JP) 2003-097318

(51) Int. Cl. B32B 3/02

(52) U.S. Cl. 428/65.3; 428/694 BS

(57) ABSTRACT

Disclosed is a perpendicular magnetic recording medium including a nonmagnetic substrate, a multilayered underlayer which includes a ferromagnetic underlayer having a perpendicular coercive force of 39.5 kA/m or less and a weakly magnetic underlayer having a saturation magnetization Ms of 50 to 150 emu/cc, and a perpendicular magnetic recording layer.

### CROSS-REFERENCE TO RELATED APPLICATIONS

This application is based upon and claims the benefit of priority from prior Japanese Patent Application No. 2003-097318, filed Mar. 31, 2003, the entire contents of which are incorporated herein by reference.

### BACKGROUND OF THE INVENTION

1. Field of the Invention

The present invention relates to a magnetic recording medium for use in, e.g., a hard disk drive using the magnetic recording technique, and a magnetic recording/reproducing apparatus using the magnetic recording medium.

2. Description of the Related Art

In the perpendicular magnetic recording system, the easy axis of magnetization of a magnetic recording layer, which is conventionally pointed in the longitudinal direction is pointed in the perpendicular direction of the medium, thereby decreasing a demagnetizing field in a magnetization transition region which is the boundary between recording bits. Therefore, as the recording density increases, the medium becomes magnetostatically stable and increases the thermal decay resistance. This makes the perpendicular magnetic recording system suited to improving the surface recording density.

Also, when a backing layer made of a soft magnetic material is formed between a substrate and perpendicular recording layer, a perpendicular magnetic recording medium functions as a so-called double-layered perpendicular medium when combined with a single pole head. In this medium, the soft magnetic backing layer can increase the recording/reproduction efficiency by returning a recording magnetic field from the magnetic head.

In this double-layered perpendicular medium, however, an underlayer for controlling the crystal orientation and crystal grain size of the perpendicular magnetic recording layer must be formed on the soft magnetic backing layer. So, the crystallinity of this underlayer is influenced by that of the soft magnetic layer. In addition, to increase the recording capability and recording resolution, the spacing between the single pole head and soft magnetic backing layer must be narrowed, so the thickness of the underlayer must also be decreased. That is, the requirements for the underlayer are very strict.

A number of methods have been proposed to decrease the size of grains in the recording layer and reduce the medium noise under the limitations as described above. For example, Jpn. Pat. Appln. KOKAI Publication No. 11-296833 discloses a multilayered structure of magnetic layers in which a Cr composition distribution changes in the direction of film thickness, or an arrangement in which an underlayer having an Ms value of less than 50 emu/cc is formed between perpendicular magnetic layers having different magnetic characteristics.

Unfortunately, the multilayered structure in which films are intermittently formed and the multilayered structure in which the Cr composition changes have the problems that the effect of decreasing the grain size is unsatisfactory, and the magnetic coupling between magnetic layers cannot be well controlled. In addition, when a nonmagnetic or weakly magnetic layer is formed as an interlayer, the magnetic characteristics of the whole medium deteriorate if the thickness of this interlayer is large.

### BRIEF SUMMARY OF THE INVENTION

The present invention provides a perpendicular magnetic recording medium comprising a nonmagnetic substrate, a multilayered underlayer formed on the nonmagnetic substrate and including a ferromagnetic underlayer having perpendicular magnetic anisotropy and a weakly magnetic underlayer stacked on the ferromagnetic underlayer, and a perpendicular magnetic recording layer formed on the weakly magnetic underlayer,

wherein the ferromagnetic underlayer has a perpendicular coercive force of 39.5 kA/m (0.5 koe) or less, and the weakly magnetic underlayer has a saturation magnetization Ms of 50 to 150 emu/cc.

The present invention also provides a magnetic recording/reproducing apparatus comprising a perpendicular magnetic recording medium which comprises a nonmagnetic substrate, a multilayered underlayer formed on the nonmagnetic substrate and including a ferromagnetic underlayer having perpendicular magnetic anisotropy and a weakly magnetic underlayer stacked on the ferromagnetic underlayer, and a perpendicular magnetic recording layer formed on the weakly magnetic underlayer, and a recording/reproducing head, wherein the ferromagnetic underlayer has a perpendicular coercive force of 39.5 kA/m (0.5 koe) or less, and the weakly magnetic underlayer has a saturation magnetization Ms of 50 to 150 emu/cc.

### BRIEF DESCRIPTION OF THE SEVERAL VIEWS OF THE DRAWING

The accompanying drawings, which are incorporated in and constitute a part of the specification, illustrate presently embodiments of the invention and, together with the general description given above and the detailed description of the embodiments given below, serve to explain the principles of the invention.

FIG. 1 is a schematic sectional view showing the first example of a perpendicular magnetic recording medium of the present invention;

FIG. 2 is a schematic sectional view showing the second example of the perpendicular magnetic recording medium of the present invention;

FIG. 3 is a schematic sectional view showing the third example of the perpendicular magnetic recording medium of the present invention;

FIG. 4 is a schematic sectional view showing the fourth example of the perpendicular magnetic recording medium of the present invention;

FIG. 5 is a partially exploded perspective view showing an example of a magnetic recording/reproducing apparatus of the present invention;

FIG. 6 is a schematic sectional view showing the fifth example of the perpendicular magnetic recording medium of the present invention;

FIG. 7 is a graph showing magnetization curves of an orientation control layer/weakly magnetic underlayer testing medium;

FIG. 8 is a graph showing magnetization curves of an orientation control layer/ferromagnetic underlayer/weakly magnetic underlayer testing medium;

FIG. 9 is a graph showing magnetization curves of an orientation control layer/ferromagnetic underlayer/weakly magnetic underlayer/perpendicular magnetic recording layer testing medium;

FIG. 10 is a graph showing magnetization curves of an orientation control layer/weakly magnetic underlayer/perpendicular magnetic recording layer testing medium;

FIG. 11 is a graph obtained by subtracting the magnetization curves shown in FIG. 8 from the magnetization curves shown in FIG. 9; and

FIG. 12 is a graph obtained by subtracting the magnetization curves shown in FIG. 7 from the magnetization curves shown in FIG. 10.

### DETAILED DESCRIPTION OF THE INVENTION

A perpendicular magnetic recording medium of the present invention has a nonmagnetic substrate, a multilayered underlayer formed on the nonmagnetic substrate, and a perpendicular magnetic recording layer formed on the multilayered underlayer. This multilayered underlayer includes a ferromagnetic underlayer and weakly magnetic underlayer in this order from the substrate side.

The ferromagnetic underlayer used in the present invention has perpendicular magnetic anisotropy and a perpendicular coercive force Hc of 39.5 kA/m (0.5 kOe) or less. The weakly magnetic underlayer used in the present invention has a saturation magnetization Ms of 50 to 150 emu/cc.

In the present invention, magnetic material is defined as weakly magnetic material when the saturation magnetization Ms is 150 emu/cc or less.

A magnetic recording/reproducing apparatus of the present invention is an apparatus to which the perpendicular magnetic recording medium described above is applied, and has this perpendicular magnetic recording medium and a recording/reproducing head.

The present invention uses the ferromagnetic underlayer having perpendicular anisotropy, a small perpendicular coercive force Hc, and a small squareness ratio Rs. Therefore, the grain size of the weakly magnetic underlayer is decreased and its crystal orientation is improved from the initial stages of growth. Consequently, the grain size of the perpendicular magnetic recording layer formed on this weak magnetic underlayer decreases, and this reduces the medium noise.

The weak magnetic underlayer has saturation magnetization smaller than that of the ferromagnetic underlayer. Therefore, exchange coupling having an appropriate magnitude is produced between the ferromagnetic underlayer and perpendicular magnetic recording layer, i.e., a magnetic interaction is exerted between them. This effectively prevents deterioration of the magnetic characteristics of the whole perpendicular magnetic recording medium. Also, the medium noise can be reduced by the multilayered structure of the underlayer.

FIG. 1 is a schematic sectional view showing the arrangement of the first example of the perpendicular magnetic recording medium according to the present invention.

As shown in FIG. 1, a perpendicular magnetic recording medium 10 has an arrangement in which a multilayered underlayer 4 made up of a ferromagnetic underlayer 2 and weak magnetic underlayer 3, and a perpendicular magnetic recording layer 5 are formed in this order on a nonmagnetic substrate 1.

A soft magnetic backing layer can also be formed between the nonmagnetic substrate and multilayered underlayer used in the present invention.

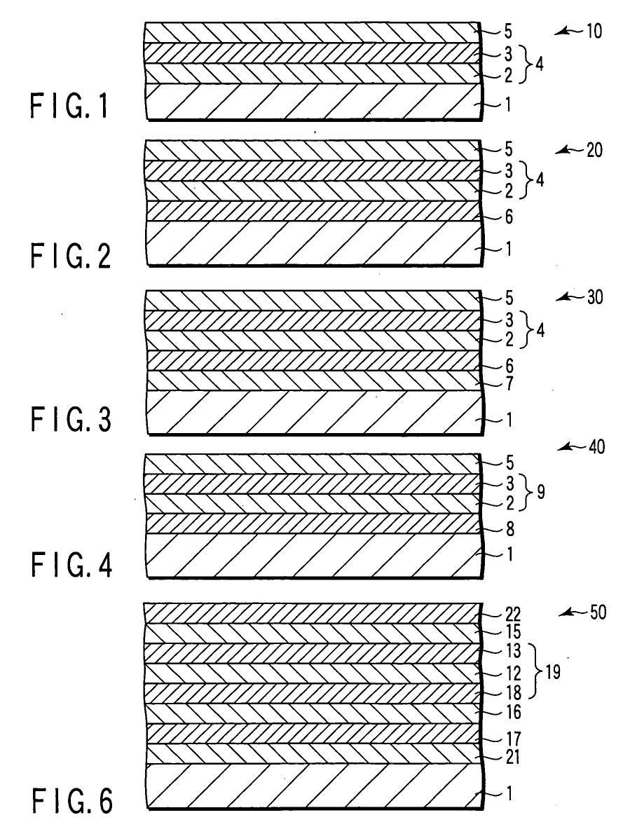

FIG. 2 is a schematic sectional view showing the arrangement of the second example of the perpendicular magnetic recording medium according to the present invention.

As shown in FIG. 2, a perpendicular magnetic recording medium 20 has the same arrangement as that of the perpendicular magnetic recording medium shown in FIG. 1 except that a soft magnetic backing layer 6 is formed between a nonmagnetic substrate 1 and multilayered underlayer 4.

Since the soft magnetic backing layer prevents oriented growth of the ferromagnetic underlayer formed on it, the Hc and Rs values of the ferromagnetic underlayer further decrease.

When a soft magnetic backing layer having high magnetic permeability is formed, a so-called double-layered perpendicular medium having a perpendicular magnetic recording layer on this soft magnetic backing layer is obtained. In this double-layered perpendicular medium, the soft magnetic backing layer performs part of the function of a magnetic head, e.g., a single pole head, for magnetizing the perpendicular magnetic recording layer; the soft magnetic backing layer horizontally passes a recording magnetic field from the magnetic head and returns a recording magnetic field to the magnetic head. That is, the soft magnetic backing layer can apply a steep sufficient perpendicular magnetic field to the magnetic recording layer, thereby increasing the recording/reproduction efficiency.

As the soft magnetic backing layer, materials containing Fe, Ni, and Co can be used. Examples are FeCo-based alloys such as FeCo and FeCoV, FeNi-based alloys such as FeNi, FeNiMo, FeNiCr, and FeNiSi, FeAl-based alloys, FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN.

It is also possible to use a material having a fine crystal structure of, e.g., FeAlO, FeMgO, FeTaN, or FeZnN containing 60 at % or more of Fe, or a granular structure in which fine crystal grains are dispersed in a matrix.

As still another material of the soft magnetic backing layer, a Co alloy containing Co and at least one of Zr, Hf, Nb, Ta, Ti, and Y can be used. In one embodiment, the content of Co can be 80 at % or more. When a film of this Co alloy is formed by sputtering, an amorphous layer is easily formed. An amorphous soft magnetic material has none of crystal magnetic anisotropy, crystal defects, and grain boundaries, and hence exhibits excellent soft magnetism. In addition, the medium noise can be reduced by the use of this amorphous soft magnetic material.

Examples of the amorphous soft magnetic material can be CoZr-based, CoZrNb-based, and CoZrTa-based alloys.

A longitudinal hard magnetic layer, in some embodiment, a longitudinal hard magnetic layer containing Co can be further formed between the nonmagnetic substrate and soft magnetic backing layer.

FIG. 3 is a schematic sectional view showing the third example of the perpendicular magnetic recording medium of the present invention.

As shown in FIG. 3, a perpendicular magnetic recording medium 30 has the same arrangement as shown in FIG. 2 except that a longitudinal hard magnetic layer 7 is formed between a nonmagnetic substrate 1 and soft magnetic layer 6.

The soft magnetic backing layer readily forms a magnetic domain, and this magnetic domain generates spike noise. The generation of a magnetic wall can be prevented by applying a magnetic field in one direction of the radial direction of the longitudinal hard magnetic layer, thereby applying a bias magnetic field to the soft magnetic backing layer formed on the longitudinal hard magnetic layer.

As the longitudinal hard magnetic layer, in one embodiment, it is possible to use, e.g., a CoCrPt alloy or CoSm alloy. In one embodiment, the coercive force of the longitudinal hard magnetic layer can be 39,500 A/m (500 Oe) or more, and further in some embodiments, it can be 79,000 A/m (1,000 Oe) or more. In one embodiment, the thickness of the longitudinal hard magnetic layer can be 5 to 150 nm, and further in some embodiments, it can be 10 to 70 nm. To control the crystal orientation of this longitudinal hard magnetic layer, a Cr alloy material or B2 structure material can be used between the nonmagnetic substrate and longitudinal hard magnetic layer.

An oxidized layer can be formed between the soft magnetic backing layer and multilayered underlayer.

This oxidized layer has no crystalline orientation. Therefore, when a thin film is formed on the surface of this oxidized layer, good crystal orientation is difficult to obtain especially in the initial stages of growth.

The oxidized layer can be formed by, e.g., a method of exposing the soft magnetic backing layer to an oxygen-containing ambient, or a method of supplying oxygen during the process of forming a surface portion of the soft magnetic backing layer. More specifically, when the surface of the soft magnetic backing layer is to be exposed to oxygen, the soft magnetic backing layer can be held for 0.3 to about 20 seconds in oxygen or in a gas ambient in which oxygen is diluted by a gas such as argon or nitrogen. The oxidized layer can also be formed by exposure to the atmosphere.

Especially when a gas formed by diluting oxygen with a gas such as argon or nitrogen is to be used, the degree of oxidation of the surface of the soft magnetic backing layer can be easily adjusted. This makes stable manufacture feasible. Also, when oxygen is to be supplied to the gas for forming the soft magnetic backing layer and sputtering is to be used in this film formation, sputtering can be performed by using a process gas to which oxygen is supplied only for part of the film formation time.

Furthermore, an orientation control layer for controlling the crystal orientation of the ferromagnetic underlayer can be formed in the multilayered underlayer of the perpendicular magnetic recording medium of the present invention.

FIG. 4 is a schematic sectional view showing the fourth example of the perpendicular magnetic recording medium of the present invention.

As shown in FIG. 4, a perpendicular magnetic recording medium 40 has an arrangement in which a multilayered underlayer 9 made up of an orientation control layer 8, ferromagnetic underlayer 2, and weak magnetic underlayer 3, and a perpendicular magnetic recording layer 5 are stacked on a nonmagnetic substrate 1.

This orientation control layer is formed on that surface of the ferromagnetic underlayer, which faces the substrate, and has a fine crystal structure having an average grain size of 3 nm or less. This gives the multilayered underlayer a multilayered structure in which the orientation control layer, ferromagnetic underlayer, and weak magnetic underlayer are stacked in this order from the substrate side.

When the fine-crystal orientation control layer having no sufficient crystal orientation is formed below the ferromagnetic underlayer, no epitaxial growth of the ferromagnetic underlayer occurs, and the perpendicular anisotropy readily lowers in the initial stages of growth. This facilitates the formation of a ferromagnetic layer having a small perpendicular coercive force Hc.

In one embodiment, the material of this orientation control layer can contain at least one element selected from the group consisting of Ta, Nb, Co, Ni, and C. Examples are alloys such as Ta, Nb, NiTa, NiNb, CoTa, CoNb, NiTaC, NiNbC, CoNiTa, and CoNiNb. When any of these materials is used, a fine-crystal orientation control layer having no sufficient crystal alignment can be obtained. The same effect can be obtained by using a CoW or CoNd alloy as the orientation control layer instead of the above-mentioned materials.

In one embodiment, the saturation magnetization Ms of the orientation control layer can be 0 to 200 emu/cc. If the Ms value of the orientation control layer exceeds 200 emu/cc, the recording/reproduction characteristics tend to worsen due to noise generated from the orientation control layer. Also, the composition of the orientation control layer is desirably so determined that the best recording/reproduction characteristics are obtained. Although an orientation control layer of an optimum composition may have magnetization, it need not particularly have magnetization. Generally, the Ms value is presumably as small as possible when the generation of noise is taken into consideration.

The thickness of the orientation control layer can be 1 to 20 nm, and more suitably, 1 to 12 nm. When the thickness of the orientation control layer is 1 to 20 nm, the perpendicular orientation of the perpendicular magnetic recording layer is particularly high, and the distance between a magnetic head and the soft magnetic backing layer can be decreased during recording. Therefore, the recording/reproduction characteristics can be further improved without lowering the resolution of a reproduction signal.

In one embodiment, the ferromagnetic underlayer used in the present invention can have a perpendicular coercive force of 0 to 0.5 kOe. Since this ferromagnetic underlayer is positioned far from a recording head, satisfactory recording is difficult to perform if the Hc value exceeds 39.5 kA/m (0.5 kOe). If the Rs value of the ferromagnetic underlayer is also high, this high Rs value can produce a noise source. However, the noise does not increase in the present invention because both the Hc and Rs values are low.

In one embodiment, the saturation magnetization of the ferromagnetic underlayer can be larger than that of the weak magnetic underlayer, and moreover in some instances, 300 to 1,000 emu/cc.

By making the saturation magnetization of the ferromagnetic underlayer larger than that of the weak magnetic underlayer, it is possible to more effectively decrease the grain size of the weak magnetic underlayer from the initial stages of growth. Since this decreases the grain size of the perpendicular magnetic recording layer formed on the weak magnetic underlayer, the medium noise can be further reduced. If this saturation magnetization is less than 300 emu/cc, the medium noise reducing effect tends to decrease even when the ferromagnetic underlayer is formed, probably because the grain size decreasing effect resulting from magnetization decreases. If the saturation magnetization exceeds 1,000 emu/cc, the medium noise tends to increase because segregation becomes insufficient to increase the substantial grain size of the ferromagnetic underlayer.

For instance, in one embodiment, the ferromagnetic underlayer having perpendicular magnetic anisotropy used in the present invention can have a thickness of 0.5 to 5 nm.

The Hc value decreases by relatively decreasing the thickness of the ferromagnetic underlayer. Also, the spacing between a head and the soft magnetic layer of the double-layered perpendicular medium can be reduced. If the thickness of the ferromagnetic layer is less than 0.5 nm, the medium noise reducing effect tends to decrease presumably because no even thin film can be formed any longer. If this thickness exceeds 5 nm, satisfactory recording tends to be difficult to perform.

As the material of the ferromagnetic underlayer, it is possible to use an alloy obtained by adding to CoCrPt at least one element selected from the group consisting of Mo, Ta, B, Nb, Hf, Ir, Cu, Ru, Nd, Zr, W, and Nd. It is also possible to use a CoCr-based alloy, CoPt-based alloy, CoPtO, CoPtCrO, CoPtSi, CoPtCrSi, CoPtSiO, and CoPtCrSiO.

Moreove in some instances, an alloy layer mainly containing Co, Cr, and Pt can be used. Examples are CoCrPtMo, CoCrPtTa, CoCrPtB, CoCrTa, and CoCrPt.

The weak magnetic underlayer used in the present invention has a saturation magnetization Ms of 50 emu/cc to 150 emu/cc.

If this saturation magnetization is less than 50 emu/cc, the ferromagnetic underlayer functions magnetically independently of the magnetic recording layer, so no magnetic interaction acts. Consequently, the low Hc and Rs values of the ferromagnetic underlayer largely deteriorate the magnetic characteristics of the whole medium. If the saturation magnetization exceeds 150 emu/cc, noise generated from the weak magnetic interlayer itself increases to worsen the recording/reproduction characteristics.

For example, in one embodiment, the weak magnetic underlayer can have a thickness of 30 nm or less, and moreover in some embodiments, it can be 5 to 20 nm.

Relatively increasing the thickness of the weak magnetic underlayer has an effect of improving the crystallinity of the perpendicular magnetic recording layer formed on this weak magnetic underlayer, thereby reducing the medium noise. This also appropriately weakens the interaction which magnetically connects magnetic grains between the ferromagnetic underlayer and perpendicular magnetic recording layer. Accordingly, the magnetic grains of these two perpendicular magnetic films effectively reverse independently of each other, and the films substantially function as a multilayered structure, so the medium noise can be reduced. If the thickness of the weak magnetic underlayer is less than 5 nm, the crystallinity of the perpendicular magnetic recording layer formed on this weak magnetic underlayer tends to deteriorate and worsen the magnetic characteristics and recording/reproduction characteristics. The recording/reproduction characteristics also suffer because the multilayer effect tends to become difficult to obtain. If this thickness exceeds 20 nm, a reproduction waveform tends to be distorted because the distance between the perpendicular magnetic recording layer and soft magnetic underlayer increases. In addition, since the distance between a magnetic head and the soft magnetic underlayer tends to increase, recording tends to become unsatisfactory to increase the medium noise.

As the material of the weak magnetic underlayer, it is possible to use an alloy obtained by adding to CoCr at least one element selected from the group consisting of Pt, B, Ta, Mo, Nb, Hf, Ir, Cu, Ru, Nd, Zr, W, and Nd, or an alloy obtained by adding to Co at least one element selected from the group consisting of Ru, Rd, Pd, Pt, Si, Ge, O, and N.

For instance, in one embodiment, it is possible to use an alloy mainly containing CoCr and further containing Pt, B, and Ta. This alloy layer has a Co content of 30 to 70 at %, and in one embodiment, it has an HCP (Hexagonal Closest Packed) structure. The alloy layer mainly containing CoCr can improve the perpendicular orientation of the perpendicular magnetic recording layer. Accordingly, it is possible to advantageously improve the magnetic characteristics such as the coercive force and perpendicular squareness ratio, and the recording/reproduction characteristics such as the medium noise and recording resolution, and increase the thermal decay resistance.

Moreover in one embodiment, Co, Cr, and Pt can be contained.

The weak magnetic underlayer further can contain B in addition to Co, Cr, and Pt, and for instance, in one embodiment, it can contain 23 to 35 at %, and moreover in some embodiments, it can contain 27 to 33 at % of Cr and B in total.

When the total of the Cr and B contents in the weak magnetic underlayer is 27 to 33 at %, a saturation magnetization Ms of 50 to 150 emu/cc can be obtained.

As the nonmagnetic substrate, it is possible to use, e.g., a glass substrate, an Al-based alloy substrate, ceramic, carbon, an Si single-crystal substrate having an oxidized surface, and a substrate obtained by plating any of these substrates with NiP or the like.

Examples of the glass substrate are amorphous glass and crystallized glass, and general-purpose soda-lime glass or aluminosilicate glass can be used as the amorphous glass. Also, lithium-based crystallized glass can be used as the crystallized glass. As the ceramic substrate, it is possible to use, e.g., a general-purpose sintered material mainly containing aluminum oxide, aluminum nitride, or silicon nitride, or a fiber-reinforced product of this sintered material.

The perpendicular magnetic recording layer used in the present invention can contain Co, Cr, and Pt as main components. The Cr content can be 14 to 24 at %, and moreover in some embodiments, it can be 16 to 22 at %. For example in one embodiment, the Pt content can be 10 to 24 at %, and moreover in some embodiments, it can be 14 to 20 at %.

For instance ,in one embodiment, 0.1 to 5 at % of B can also be added. This makes it possible to reduce the exchange coupling between magnetic grains, and improve the recording/reproduction characteristics.

If the Cr content is less than 14 at %, the exchange coupling between magnetic grains tends to increase to increase the medium noise. If the Cr content exceeds 24 at %, the coercive force and perpendicular squareness ratio tend to lower.

If the Pt content is less than 10 at %, the effect of improving the recording/reproduction characteristics becomes unsatisfactory, and the perpendicular squareness ratio tends to lower so as to worsen the thermal decay resistance. If the Pt content exceeds 24 at %, the medium noise tends to increase.

An arbitrary element can also be added to the CoCrPt-based alloy in addition to B. Examples of this arbitrary element are Ta, Mo, Nb, Hf, Ir, Cu, Ru, Nd, Zr, W, and Nd, although the elements are not particularly limited.

As the perpendicular magnetic recording layer, it is also possible to use a CoCr-based alloy, a CoPt-based alloy, CoPtO, CoPtCrO, CoPtSi, CoPtCrSi, CoPtSiO, CoPtCrSiO, multilayered structures of Co and alloys mainly containing at least one element selected from the group consisting of Pt, Pd, Rh, and Ru, and CoCr/PtCr, CoB/PdB, and CoO/RhO obtained by adding Cr, B, and O to these multilayered structures.

In one embodiment, the thickness of the perpendicular magnetic recording layer can be 5 to 60 nm, and moreover in some embodiments, it can be 10 to 40 nm. When the thickness falls within this range, the medium can operate as a magnetic recording/reproducing device more suited to a high recording density. If the thickness of the perpendicular magnetic recording layer is less than 5 nm, the reproduction output becomes too low, and this tends to increase the noise. component. If the thickness of the perpendicular magnetic recording layer exceeds 40 nm, the reproduction output becomes too high, and this tends to distort the waveform.

In one embodiment, the coercive force of the perpendicular magnetic recording layer can be 237,000 A/m (3,000 Oe) or more. If this coercive force is less than 237,000 A/m (3,000 Oe), the thermal decay resistance tends to decrease.

In one embodiment, the perpendicular squareness ratio of the perpendicular magnetic recording layer can be 0.8 or more. If this perpendicular squareness ratio is less than 0.8, the thermal decay resistance tends to decrease.

A protective layer can be formed on the perpendicular magnetic recording layer.

This protective layer is formed in order to prevent corrosion of the perpendicular magnetic recording layer, and also prevent damage to the medium surface when a magnetic head comes in contact with the medium. Examples of the material are those containing C, SiO₂, and ZrO₂.

In one embodiment, the thickness of the protective layer can be 1 to 10 nm. This thickness is suited to high-density recording because the distance between a head and the medium can be decreased.

Furthermore, a lubricating layer can be formed on the protective layer.

As a lubricating agent used in this lubricating layer, it is possible to use a conventionally known material, e.g., perfluoropolyether, alcohol fluoride, or fluorinated carboxylic acid.

The magnetic recording/reproducing apparatus of the present invention comprises the magnetic recording medium described above, a driving mechanism for supporting and rotating the magnetic recording medium, a magnetic head having an element for recording information on the perpendicular magnetic recording medium and an element for reproducing the recorded information, and a carriage assembly which supports the magnetic head such that the magnetic head can freely move with respect to the magnetic recording medium.

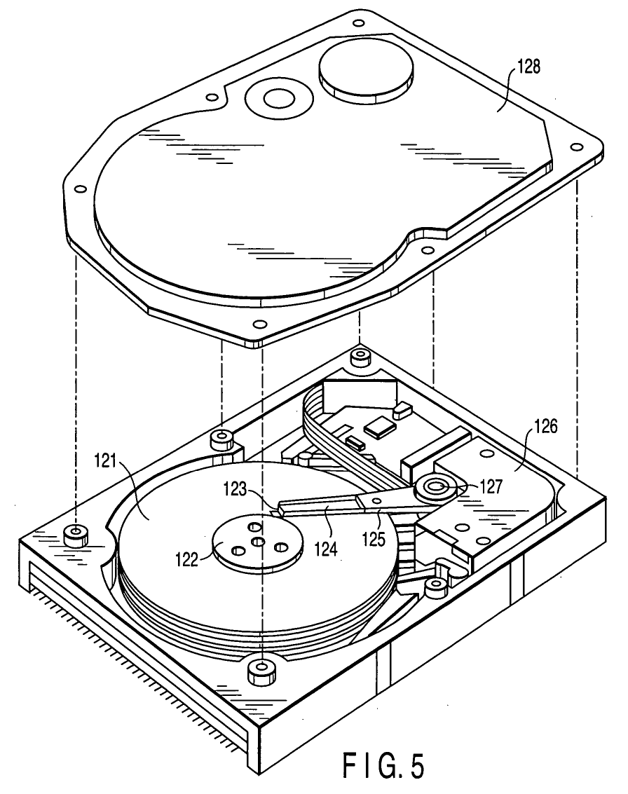

FIG. 5 is a partially exploded perspective view showing an example of the magnetic recording/reproducing apparatus of the present invention.

A rigid magnetic disk 121 for recording information according to the present invention is fitted on a spindle 122 and rotated at a predetermined rotational speed by a spindle motor (not shown). A slider 123 mounting a single pole recording head for accessing the magnetic disk 121 to record information and an MR head for reproducing information is attached to the distal end portion of a suspension 124 which is a thin leaf spring. The suspension 124 is connected to one end of an arm 125 having, e.g., a bobbin which holds a driving coil (not shown).

A voice coil motor 126 as a kind of a linear motor is attached to the other end of the arm 125. The voice coil motor 126 includes the driving coil (not shown) wound around the bobbin of the arm 125, and a magnetic circuit having a permanent magnetic and counter yoke opposing each other on the two sides of the driving coil.

The arm 125 is held by ball bearings (not shown) formed in two, upper and lower portions of a fixed shaft 127, and pivoted by the voice coil motor 126. That is, the position of the slider 123 on the magnetic disk 121 is controlled by the voice coil motor 126. Reference numeral 128 in FIG. 5 denotes a lid.

### EMBODIMENTS

The present invention will be described in detail below by way of its embodiments.

### Embodiment 1

As a nonmagnetic substrate, a disk-like cleaned glass substrate (manufactured by OHARA, outside diameter=2.5 in) was prepared.

This glass substrate was placed in a film formation chamber of a DC magnetron sputtering apparatus (C-3010 manufactured by ANELVA) The film formation chamber was evacuated to a base pressure of 2×10^{-5 Pa and heated to about} 200° C., and sputtering was performed as follows in an Ar atmosphere at a gas pressure of 0.6 Pa.

First, a 40-nm thick CrMo alloy layer was formed as a nonmagnetic underlayer on the nonmagnetic substrate.

On top of this nonmagnetic underlayer, a 40-nm thick Co-22 at % Cr-13 at % Pt hard magnetic layer was deposited to form a longitudinally oriented hard magnetic layer.

On this hard magnetic layer, a 250-nm thick Co-5 at % Zr-8 at % Nb alloy layer was formed as a soft magnetic backing layer. The resultant substrate was once taken out from the vacuum chamber into the air atmosphere.

The substrate cooled in the atmosphere was returned to the vacuum chamber and heated to about 300° C., and DC magnetron sputtering was performed as follows in the Ar atmosphere at a gas pressure of 0.6 Pa.

First, a 5-nm thick Ni-40 at % Ta orientation control layer was formed.

Subsequently, a 3-nm thick Co-14 at % Cr-14 at % Pt-5 at % Mo alloy layer was formed as a ferromagnetic underlayer.

Then, a 12-nm thick weakly magnetic underlayer made of a Co-26 at % Cr-12 at % Pt-4 at % B alloy was formed.

After that, a 16-nm thick Co-14 at % Cr-14 at % Pt-Sat % Mo alloy layer was formed as a perpendicular magnetic recording layer.

A 7-nm thick C layer was then formed on the obtained perpendicular magnetic recording layer.

The substrate subjected to sputtering as described above was taken out from the vacuum chamber, and a perfluoropolyether lubricating layer was formed on the protective film by dipping, thereby obtaining a perpendicular magnetic recording medium.

FIG. 6 is a schematic sectional view showing the obtained perpendicular magnetic recording medium.

As shown in FIG. 6, a perpendicular magnetic recording medium 50 has an arrangement in which a nonmagnetic underlayer 21, a longitudinal hard magnetic layer 17, a soft magnetic backing layer 16, a multilayered underlayer 19 made up of an orientation control layer 18, ferromagnetic underlayer 12 and weak magnetic underlayer 13, a perpendicular magnetic recording layer 15, a protective layer 22, and a lubricating layer (not shown) are deposited in this order on a nonmagnetic substrate 1.

A magnetizing apparatus having an exclusively formed electromagnet was used to apply a magnetic field of 15 kOe outward in the radial direction of the disk-like substrate of the obtained perpendicular magnetic recording medium, thereby magnetizing the CoCrPt longitudinal hard magnetic layer in the radial direction. All perpendicular magnetic recording media to be described below were thus magnetized unless otherwise specified.

The recording/reproduction characteristics of the thus manufactured perpendicular magnetic recording medium were evaluated by using read write analyzer 1632 and spin stand S1701MP available from GUZIK of U.S.A. As a recording/reproducing head, a head using a single magnetic pole as a recording unit and a magnetoresistance effect as a reproducing element was used.

In the evaluation of a reproduction signal output/medium noise ratio (S/Nm), a value obtained at a linear recording density of 50 kFCI was used as a reproduction signal output S, and a value obtained at a linear recording density of 500 kFCI was used as S/Nm.

As a consequence, no spike noise was observed on the entire disk surface, and the S/Nm value was 20.2 dB, a favorable value.

Also, magnetization curves were measured by changing the sweep time from 300 to 15 sec by using a polar Kerr effect measurement apparatus. The magnitude of an activation magnetic moment (v·Isb) as the product of a reversal unit v of magnetization and its saturation magnetization Isb was calculated from a coercive force Hc in the hysteresis loop and the sweep time. As a consequence, the value of v·Isb was as small as 0.95×10⁻¹⁵ emu.

In addition, when the sectional structure of the medium was observed with a transmission electron microscope (TEM), a white film about 2 nm thick was observed between the CoZrNb soft magnetic backing layer and the NiTa orientation control layer. This indicates that an oxidized layer was formed in the surface layer of the CoZrNb soft magnetic backing layer since the medium was exposed to the air atmosphere during the process.

Furthermore, the planar structure of the NiTa orientation control layer was observed by using the TEM. Consequently, neither clear crystal grains nor clear grain boundaries were observed, and grain-like materials about 2 to 3 nm in diameter were scattered. When ω−2θ scan was also performed using an X-ray diffraction (XRD) apparatus, no peak of the NiTa layer was observed. In a selected-area diffraction image, however, a weak ring corresponding to an HCP (Hexagonal Closest Packed) structure was observed. Therefore, this NiTa orientation control layer presumably had a fine crystal structure.

### Comparative Example 1

A perpendicular magnetic recording medium was obtained following the same procedures as in Embodiment 1 except that after an orientation control layer was formed, a weak magnetic underlayer was formed without forming any Co-14 at % Cr-14 at % Pt-5 at % Mo alloy layer as a ferromagnetic underlayer.

When the recording/reproduction characteristics of the obtained perpendicular magnetic recording medium were evaluated in the same manner as in Embodiment 1, the S/Nm value was 19.2 dB.

Also, the value of v·Isb was measured in the same manner as in Embodiment 1 and found to be 1.03×10⁻¹⁵ emu.

The S/Nm value was smaller than that in Embodiment 1, and the v·Isb value was larger than that in Embodiment 1.

A high S/Nm value was obtained in Embodiment 1 presumably because the activation magnetic moment reduced as described above. This indicates that the formation of the CoCrPtMo ferromagnetic layer has an effect of reducing the medium noise.

### Embodiment 2

To check the magnetism of a CoCrPtMo ferromagnetic underlayer and the influence of this magnetism on a perpendicular magnetic recording layer, a testing medium for evaluation by a vibrating sample magnetometer (VSM) was first formed.

In this VSM measurement, if a CoZrNb soft magnetic backing layer is also formed, not only the magnetization of a perpendicular magnetic recording layer but also that of this soft magnetic backing layer is measured. This makes it impossible to well evaluate the magnetic characteristics of a perpendicular magnetic recording layer having relatively small magnetization and a small layer thickness. Therefore, to obtain a surface temperature equivalent to that of the aforementioned medium for recording/reproduction characteristic evaluation during substrate heating, a 150-nm thick Ni-40 at % Ta layer and 10-nm thick C layer, instead of a longitudinal hard magnetic layer and soft magnetic backing layer, were formed in this order on a glass substrate, thereby forming a substrate having a nonmagnetic backing layer. The resultant medium was once taken out from the vacuum chamber into the atmosphere.

By using this nonmagnetic backed substrate, a testing medium was obtained by forming an NiTa orientation control layer, CoCrPtMo ferromagnetic underlayer, CoCrPtB weak magnetic layer, CoCrPtMo perpendicular magnetic recording layer, and C protective layer in this order following the same procedures as in Embodiment 1.

When polar Kerr effect measurement was performed, magnetic characteristics substantially equal to those of the recording/reproduction characteristic evaluation medium described above were obtained from the obtained testing medium.

Also, an orientation control layer/weak magnetic underlayer testing medium was formed by first forming a 5-nm thick NiTa orientation control layer on a similar nonmagnetic backed substrate, and then forming a 12-nm thick CoCrPtB weak magnetic underlayer and C protective layer in this order under the same conditions as in Embodiment 1.

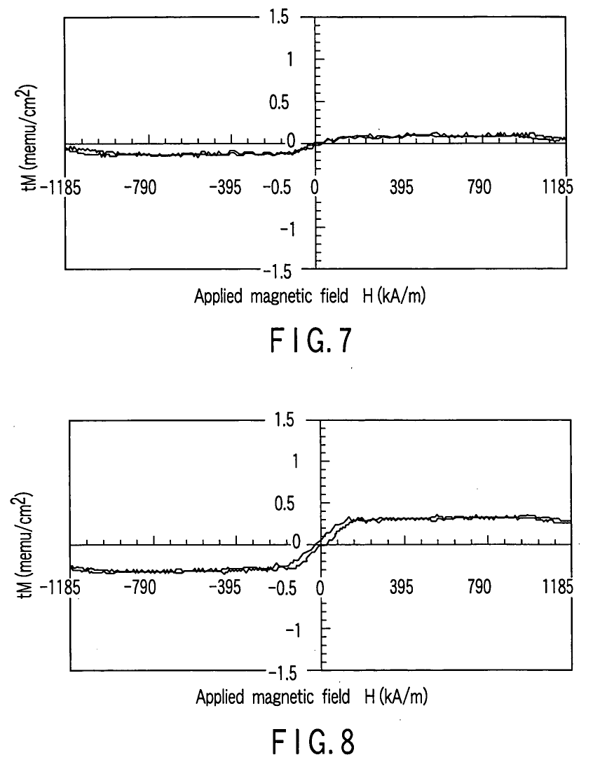

A middle portion in the radial direction of this testing medium was cut into a square piece of 1 cm², and magnetization curves were measured by applying a magnetic field in a direction perpendicular to the film surface by using the VSM. FIG. 7 shows the magnetization curves.

Since a product t·Ms of a thickness t of the CoCrPtB weak magnetic underlayer as a magnetic layer and saturation magnetization Ms was about 0.1 memu/cm², the Ms value of the CoCrPtB interlayer was presumably about 80 emu/cc.

Then, an orientation control layer/ferromagnetic underlayer/weak magnetic underlayer testing medium was formed by forming a 5-nm thick NiTa orientation control layer, 3-nm thick CoCrPtMo ferromagnetic underlayer, 12-nm thick CoCrPtB weak magnetic underlayer, and C protective layer in this order on a similar nonmagnetic backed substrate.

A middle portion in the radial direction of this testing medium was cut into a square piece of 1 cm², and magnetization curves were measured by applying a magnetic field in a direction perpendicular to the film surface by using the VSM. FIG. 8 shows the magnetization curves. A product t·Ms of a total thickness t of the ferromagnetic underlayer/weak magnetic underlayer as magnetic layers and the saturation magnetization Ms was about 0.3 memu/cm². By calculating a difference from FIG. 7, the t·Ms value of the CoCrPtMo ferromagnetic underlayer was about 0.2 memu/cm², so the Ms value was presumably about 670 emu/cc.

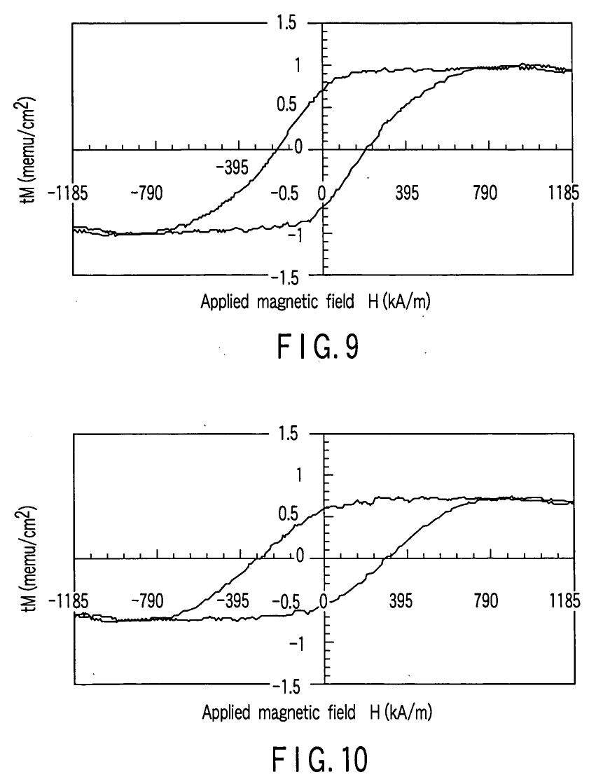

Furthermore, following the same procedures as for the recording/reproduction characteristic evaluation medium, an orientation control layer/ferromagnetic underlayer/weak magnetic underlayer/perpendicular magnetic recording layer testing medium was formed by forming a 5-nm thick NiTa orientation control layer, 3-nm thick CoCrPtMo ferromagnetic underlayer, 12-nm thick CoCrPtB weak magnetic underlayer, 16-nm thick CoCrPtMo perpendicular magnetic recording layer, and C protective layer in this order on a similar nonmagnetic backed substrate. A middle portion in the radial direction of this testing medium was cut into a square piece of 1 cm², and magnetization curves were measured by applying a magnetic field in a direction perpendicular to the film surface by using the VSM. FIG. 9 shows the magnetization curves.

A product t·Ms of a total thickness t of the ferromagnetic underlayer/weak magnetic underlayer/perpendicular magnetic recording layer as magnetic layers and the saturation magnetization Ms was about 0.9 memu/cm². By calculating a difference from FIG. 8, the t·Ms value of the CoCrPtMo perpendicular magnetic recording layer was about 0.6 memu/cm², so the Ms value was presumably about 380 emu/cc.

In addition, an orientation control layer/weak magnetic underlayer/perpendicular magnetic recording layer testing medium was formed by forming a 5-nm thick NiTa orientation control layer, 12-nm thick CoCrPtB weak magnetic underlayer, 16-nm thick perpendicular magnetic recording layer, and C protective layer in this order on a similar nonmagnetic backed substrate under the same conditions as in Embodiment 1.

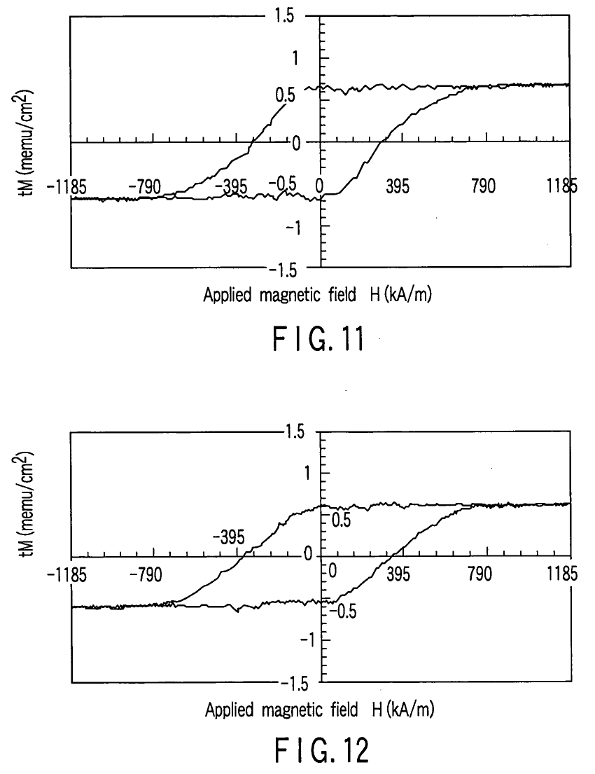

A middle portion in the radial direction of this testing medium was cut into a square piece of 1 cm², and magnetization curves were measured by applying a magnetic field in a direction perpendicular to the film surface by using the VSM. FIG. 10 shows the magnetization curves.

A product t·Ms of a total thickness t of the weak magnetic underlayer/perpendicular magnetic recording layer as magnetic layers and the saturation magnetization Ms was about 0.7 memu/cm². By calculating a difference from FIG. 7 indicating the magnetization curves of the orientation control layer/weak magnetic underlayer testing medium, the t·Ms value of the CoCrPtMo perpendicular magnetic recording layer was about 0.6 memu/cm², so the Ms value was presumably about 380 emu/cc. That is, the magnitude of the saturation magnetization of the perpendicular magnetic recording layer remained the same regardless of whether the underlayer was formed.

To check the relationship between the ferromagnetic underlayer, weak magnetic underlayer, and perpendicular magnetic recording layer, the magnetization curves shown in FIG. 8 were simply subtracted from the magnetization curves shown in FIG. 9, and the magnetization curves shown in FIG. 7 were simply subtracted from the magnetization curves shown in FIG. 10, thereby extracting magnetization curves of portions corresponding to the CoCrPtMo perpendicular magnetic recording layer. The results are shown in FIGS. 11 and 12. Since the shapes of the magnetization curves shown in FIGS. 10 and 12 are different, a magnetic interaction probably acted between the perpendicular magnetic recording layer and weak magnetic underlayer. In addition, since the shapes of the magnetization curves shown in FIGS. 11 and 12 are also different, it is assumed that a magnetic interaction also acted between the ferromagnetic underlayer, weak magnetic underlayer, and perpendicular magnetic recording layer, magnetic grains in these three layers reversed together, and the magnetization of the ferromagnetic underlayer had influence on the magnetic characteristics of the perpendicular magnetic recording layer.

Furthermore, magnetic grains in the ferromagnetic underlayer did not reverse independently of the perpendicular magnetic recording layer. Therefore, it is assumed that even when the Hc and Rs values of the magnetic characteristics of the ferromagnetic underlayer alone are low, this ferromagnetic underlayer does not necessarily deteriorate the whole magnetic characteristics including the weak magnetic underlayer and perpendicular magnetic recording layer, or does not function as an independent medium noise source.

From FIG. 7, both the coercive force Hc and saturation magnetization Ms of the CoCrPtB weak magnetic underlayer were small, and the magnitude of the saturated magnetic field Hs was substantially equal to that of the demagnetizing field, i.e., about 79 kA/m (1 kOe). Therefore, the perpendicular magnetic anisotropy was small even if it existed. In contrast, although the coercive force of the NiTa orientation control layer/CoCrPtMo ferromagnetic underlayer/CoCrPtB weak magnetic underlayer testing medium described above was small, the magnitude of its saturated magnetic field was about 158 kA/m (2 kOe), i.e., clearly smaller than about 663.6 kA/m (8.4 kOe), as shown in FIG. 8, as the magnitude 4 πMs of the demagnetizing field. Accordingly, this medium obviously had perpendicular magnetic anisotropy. Since the thickness of the CoCrPtMo ferromagnetic underlayer formed on the NiTa orientation control layer was as small as 3 nm, no peak indicating its crystal orientation was found by X-ray diffraction measurement. However, the orientation control layer had no satisfactory crystal orientation, so it is generally assumed that the closest packed face grew parallel to the film surface (accordingly, the C axis was perpendicular to the film surface). Therefore, the easy axis of magnetization presumably readily pointed in the perpendicular direction in respect of crystal orientation.

A CoCrPt-based alloy layer generally grows such that the closest packed face grows parallel to the film surface. Hence, the ferromagnetic underlayer need not be formed on the NiTa orientation control layer. However, an orientation control layer having a fine crystal structure has an effect of decreasing the grain size of the ferromagnetic underlayer, so an orientation control layer like this can be formed. Also, this orientation control layer can have no distinct crystal orientation, because no epitaxial growth occurs in the ferromagnetic underlayer. So, the crystallinity lowers in the initial stages of growth, i.e., large perpendicular magnetic anisotropy is difficult to obtain. This is favorable in the formation of a low-coercive-force underlayer.

### Embodiment 3

A perpendicular magnetic recording medium was obtained following the same procedures as in Embodiment 1 except that no NiTa orientation control layer was formed.

The recording/reproduction characteristics of the obtained perpendicular magnetic recording medium were evaluated in the same manner as in Embodiment 1. Consequently, the S/Nm value at a linear recording density of 500 kFCI was 19.4 dB, i.e., the S/Nm value in Embodiment 1 was better.

Although this might be caused by the influence of the oxidized layer on the surface of the soft magnetic backing layer, the NiTa orientation control layer presumably reduced the medium noise by making the structure and magnetic characteristics of the CoCrPtMo ferromagnetic underlayer appropriate.

Another perpendicular magnetic recording medium was obtained following the same procedures as in Embodiment 1 except that an Ni-30 at % Nb layer was formed as an orientation control layer instead of the NiTa layer.

The recording/reproduction characteristics of the obtained perpendicular magnetic recording medium were evaluated in the same manner as in Comparative Example 1. Consequently, the S/Nm value at a linear recording density of 500 kFCI was 20.0 dB, i.e., substantially equal to that in Embodiment 1.

That is, an effect equal to that of the NiTa orientation control layer was obtained even when NiNb was used as the orientation control layer.

Furthermore, perpendicular magnetic recording media were formed in the same manner as above by using NiTaC, CoNiTa, and CoTa as orientation control layers. The recording/reproduction characteristics of the obtained perpendicular magnetic recording media were evaluated in the same manner as in Comparative Example 1. Consequently, the S/Nm value at a linear recording density of 500 kFCI of any of these media was within ±0.2 dB from that in Embodiment 1, i.e., substantially equal to that of NiTa. That is, similar effects were obtained even when NiTaC, CoNiTa, and CoTa were used.

### Comparative Example 2

A perpendicular magnetic recording medium was obtained following the same procedures as in Embodiment 3 except that a weak magnetic underlayer was formed without forming neither the NiTa orientation control layer nor the CoCrPtMo ferromagnetic underlayer.

When the recording/reproduction characteristics of the obtained perpendicular magnetic recording medium were evaluated in the same manner as in Embodiment 1, the S/Nm value was 17.8 dB. This S/Nm value was obviously lower than that in Embodiment 3 in which the ferromagnetic underlayer was formed without forming any orientation control layer.

That is, the effect of reducing the medium noise was obtained even when the ferromagnetic underlayer was formed without forming any orientation control layer.

### Embodiment 4

Various perpendicular magnetic recording media were formed following the same procedures as in Embodiment 1 except that the thickness of the CoCrPtMo ferromagnetic underlayer was changed to 0.3, 0.5, 1, 2, 5, and 6 nm.

The recording/reproduction characteristics of the obtained perpendicular magnetic recording media were evaluated in the same manner as in Embodiment 1. Consequently, the S/Nm values at a linear recording density of 500 kFCI were 19.0, 19.6, 20.0, 20.2, 19.8, and 19.2 dB, respectively. The medium noise reducing effect was obtained especially when the thickness of the ferromagnetic underlayer was 0.5 to 5 nm. Therefore, the thickness of the ferromagnetic underlayer can be 0.5 to 5 nm.

The magnetic characteristics were evaluated by using the VSM in the same manner as in Embodiment 2. When the thickness of the ferromagnetic underlayer exceeded 5 nm in an orientation control layer/ferromagnetic underlayer/weak magnetic underlayer testing medium, the coercive force Hc exceeded 39.5 kA/m (0.5 kOe), and the product t·Ms of the magnetic layer thickness t and residual magnetization Ms was evidently larger than 0. As already described, it is assumed that a magnetic interaction acted between the ferromagnetic underlayer and perpendicular magnetic recording layer, and magnetic grains in these three layers reversed together. Therefore, even if the Hc value or t·Ms value of the ferromagnetic underlayer increases, these values do not directly produce independent medium noise sources. However, from the S/Nm evaluation results described above, the increase in Hc or t·Ms when the layer thickness was 5 nm or more presumably increased the medium noise. Also, since the ferromagnetic underlayer was positioned far from a magnetic head, a high Hc value might produce a noise source by making the recording state insufficient. Probably because of these reasons, high S/Nm values were obtained when the Hc value of the ferromagnetic underlayer was 39.5 kA/m (0.5 kOe) or less.

Also, to effectively reduce the medium noise by suppressing noise caused by the ferromagnetic underlayer, it is necessary to well suppress the Hc and t·Ms values of the ferromagnetic underlayer. In addition, the layer thickness must be 5 nm or less in order to reduce the spacing between a head and the soft magnetic layer in a double-layered perpendicular medium.

### Embodiment 5

Various perpendicular magnetic recording media were formed following the same procedures as in Embodiment 1 except that the contents of Cr and B in the CoCrPtB weak magnetic underlayer were changed as follows.

The Ms values of the obtained perpendicular magnetic recording media were evaluated by using the VSM in the same manner as in Embodiment 2. The recording/reproduction characteristics of these media were also evaluated in the same manner as in Embodiment 1. These evaluation results are also shown below.

| Composition (at. %) | Ms (emu/cc) | S/Nm (dB) |
|---|---|---|
| Co-28Cr-10Pt-6B | 25 | 19.0 |
| Co-28Cr-10Pt-5B | 50 | 19.8 |
| Co-27Cr-10Pt-6B | 100 | 19.6 |
| Co-25Cr-10Pt-7B | 120 | 19.8 |
| Co-25Cr-10Pt-GB | 150 | 19.4 |
| Co-23Cr-10Pt-6B | 190 | 18.8 |

Relatively high S/Nm values were obtained when the Ms value was 50 to 150 emu/cc, and the S/Nm value lowered if the Ms value fell outside this range.

### Embodiment 6

Various perpendicular magnetic recording media were formed following the same procedures as in Embodiment 1 except that the Cr content in the CoCrPtB ferromagnetic underlayer was changed as follows.

The Ms values of the obtained perpendicular magnetic recording media were evaluated by using the VSM in the same manner as in Embodiment 2. The recording/reproduction characteristics of these media were also evaluated in the same manner as in Embodiment 1. These evaluation results are also shown below.

| Composition (at. %) | Ms (emu/cc) | S/Nm (dB) |
|---|---|---|
| Co-10Cr-14Pt-5Mo | 1,080 | 18.8 |
| Co-11Cr-14Pt-5Mo | 970 | 19.4 |
| Co-12Cr-14Pt-5Mo | 880 | 20.0 |
| Co-17Cr-14Pt-5Mo | 370 | 19.8 |
| Co-18Cr-14Pt-5Mo | 280 | 19.4 |
| Co-19Cr-14Pt-5Mo | 170 | 19.4 |

The S/Nm value obviously lowered when the Ms value exceeded 1,000 emu/cc, and slightly lowered when the Ms value was less than 300 emu/cc. Accordingly, a suitable Ms range can be probably 300 to 1,000 emu/cc.

### Embodiment 7

Various perpendicular magnetic recording media were formed following the same procedures as in Embodiment 1 except that the thickness of the CoCrPtMo weak magnetic underlayer was changed to 3, 5, 9, 15, 20, and 25 nm.

The recording/reproduction characteristics of the obtained perpendicular magnetic recording media were evaluated in the same manner as in Embodiment 1. Consequently, the S/Nm values at a linear recording density of 500 kFCI were 18.6, 19.4, 20.2, 20.0, 19.6, and 19.0 dB, respectively. The S/Nm value relatively lowered when the thickness of the weak magnetic underlayer was smaller than 5 nm and larger than 20 nm.

In Embodiment 4 described above, the suitable thickness of the ferromagnetic underlayer was 0.5 to 5 nm. Compared to this, making the thickness of the weak magnetic underlayer larger than that of the ferromagnetic underlayer presumably had the effect of reducing the medium noise by improving the crystallinity of the recording layer. The medium noise was probably further reduced by the effect of the multilayered structure because the interaction between the ferromagnetic underlayer and recording layer appropriately weakened.

### Embodiment 8

Perpendicular magnetic recording media were formed following the same procedures as in Embodiment 1 except that Co-16 at % Cr-20 at % Pt-2 at % Ta and Co-10 at % Cr-8 at % Pt-16 at % B were used as CoCrPtMo ferromagnetic underlayers.

The recording/reproduction characteristics of the obtained perpendicular magnetic recording media were evaluated in the same manner as in Embodiment 1. Consequently, the S/Nm values at a linear recording density of 500 kFCI were 19.8 and 20.0 dB, respectively. That is, high SNR values equivalent to that of the CoCrPtMo ferromagnetic underlayer in Embodiment 1 were obtained.

Also, perpendicular magnetic recording media were formed following the same procedures as in Embodiment 1 except that Co-35 at % Cr-8 at % Pt-3 at % Ta, Co-19 at % Cr-10 at % Pt-2at % Ta, Co-15 at % Cr-4 at % Ta, Co-19 at % Cr-16 at % Pt-1 at % B, Co-18 at % Cr-15 at % Pt-1 at % B, and Co-20 at % Cr-20 at % Pt were used as CoCrPtMo ferromagnetic underlayers.

The recording/reproduction characteristics of the obtained perpendicular magnetic recording media were evaluated in the same manner as in Embodiment 1. Consequently, the S/Nm values at a linear recording density of 500 kFCI increased by about 0.2 dB from that in Comparative Example 1. That is, the S/Nm values were better than that when no ferromagnetic underlayer was formed.

### Embodiment 9

A perpendicular magnetic recording medium was formed following the same procedures as in Embodiment 1 except that a Co-18 at % Cr-15 at % Pt-1 at % B perpendicular magnetic recording layer was formed instead of the CoCrPtMo perpendicular magnetic recording layer.

The recording/reproduction characteristics of the obtained perpendicular magnetic recording medium were evaluated in the same manner as in Embodiment 1. Consequently, the S/Nm value at a linear recording density of 500 kFCI was 19.8 dB. That is, a high SNR value equivalent to that of the CoCrPtMo recording layer in Embodiment 1 was obtained.

This indicates that the effect of reducing the medium noise can be obtained even when a CoCrPtB alloy is used as the perpendicular magnetic recording layer.

Also, perpendicular magnetic recording media were formed following the same procedures as in Embodiment 1 and Comparative Example 1 except that Co-10 at % Cr-16 at % Pt-8 at % SiO₂ (+no heating) was used instead of the CoCrPtMo perpendicular magnetic recording layer, and a glass substrate was not heated.

The recording/reproduction characteristics of the obtained perpendicular magnetic recording media were evaluated in the same manner as in Embodiment 1. Consequently, when the CoCrPtMo underlayer was formed, the S/Nm value at a linear recording density of 500 kFCI was 17.2 dB, a slightly low value. The S/Nm value further decreased to 16.4 dB when no CoCrPtMo ferromagnetic layer was formed. That is, the value of SNR was effectively increased by the insertion of the ferromagnetic underlayer.

### Embodiment 10

A perpendicular magnetic recording medium was formed following the same procedures as in Embodiment 1 except that the soft magnetic backing layer was changed to a Co-5 at % Ta-5 at % Zr alloy layer.

The recording/reproduction characteristics of the obtained perpendicular magnetic recording medium were evaluated in the same manner as in Embodiment 1. Consequently, the S/Nm value at a linear recording density of 500 kFCI was 19.8 dB. That is, a high SNR value equivalent to that of the CoCrPtMo recording layer in Embodiment 1 was obtained.

This indicates that the effect of reducing the medium noise can be obtained even when a CoTaZr alloy is used as the soft magnetic backing layer.

In addition, various perpendicular magnetic recording media were formed by combining Co with Zr, Hf, Nb, Ta, Ti, and Y as soft magnetic backing layers, and evaluated following the same procedures as in Comparative Example 1. Consequently, similar effects were obtained although the S/Nm value varied by ±0.4 dB.

### Embodiment 11

Various perpendicular magnetic recording media were formed following the same procedures as in Embodiment 1 except that the thickness of the soft magnetic backing layer was changed between 100 and 400 nm.

The recording/reproduction characteristics of the obtained perpendicular magnetic recording media were evaluated in the same manner as in Embodiment 1. Consequently, the S/Nm value at a linear recording density of 500 kFCI increased as the thickness of the soft magnetic backing layer increased.

### Embodiment 12

A perpendicular magnetic recording medium was formed following the same procedures as in Embodiment 1 except that neither the CrMo nonmagnetic alloy layer nor the CoCrPt hard magnetic layer was formed.

The recording/reproduction characteristics of the obtained perpendicular magnetic recording medium were evaluated in the same manner as in Comparative Example 1. Consequently, a plurality of spike noise components equivalent in magnitude to a reproduction signal were observed. This indicates that because no longitudinal hard magnetic layer was formed, the easy axis of magnetization of the soft magnetic backing layer was not fixed in the radial direction of the disk, and so magnetic walls were produced. However, the S/Nm value at a linear recording density of 500 kFCI was substantially equal to that in Embodiment 1. This shows that the spike noise was effectively suppressed by the formation of the longitudinal hard magnetic layer.

In the present invention as has been explained above, the grain size of magnetic grains in the perpendicular magnetic recording layer is decreased, and this makes perpendicular magnetic recording having low medium noise and suited to high-density recording possible.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

What is claimed is:

1. A perpendicular magnetic recording medium comprising: a nonmagnetic substrate, a multilayered underlayer formed on the nonmagnetic substrate and including a ferromagnetic underlayer having perpendicular magnetic anisotropy and a weakly magnetic underlayer stacked on the ferromagnetic underlayer, and a perpendicular magnetic recording layer formed on the weakly magnetic underlayer,
wherein the ferromagnetic underlayer has a perpendicular coercive force of not more than 39.5 kA/m (0.5 kOe), and the weakly magnetic underlayer has a saturation magnetization Ms of 50 to 150 emu/cc.

2. A medium according to claim 1, further comprising a soft magnetic backing layer between the nonmagnetic substrate and the multilayered underlayer.

3. A medium according to claim 2, wherein the soft magnetic backing layer contains cobalt and at least one element selected from the group consisting of zirconium, hafnium, niobium, tantalum, titanium, and yttrium.

4. A medium according to claim 2, further comprising a cobalt-containing longitudinal hard magnetic layer between the nonmagnetic substrate and soft magnetic backing layer.

5. A medium according to claim 1, wherein the multilayered underlayer further includes an orientation control layer to control crystal orientation of the ferromagnetic underlayer, the orientation control layer being formed beneath the ferromagnetic underlayer, which faces the substrate, and having a fine crystal structure having an average grain size of not more than 3 nm.

6. A medium according to claim 5, wherein the orientation control layer contains at least one element selected from the group consisting of tantalum, niobium, cobalt, nickel, and carbon.

7. A medium according to claim 1, wherein the ferromagnetic underlayer has a saturation magnetization Ms of 300 to 1,000 emu/cc.

8. A medium according to claim 1, wherein the weakly magnetic underlayer has a thickness of 5 to 20 nm.

9. A medium according to claim 1, wherein the ferromagnetic underlayer has a thickness of 0.5 to 5 nm.

10. A medium according to claim 1, wherein at least one of the ferromagnetic underlayer, weakly magnetic underlayer, and perpendicular magnetic recording layer contains cobalt, chromium, and platinum.

11. A magnetic recording/reproducing apparatus comprising:
a perpendicular magnetic recording medium which comprises a nonmagnetic substrate, a multilayered underlayer formed on the nonmagnetic substrate and including a ferromagnetic underlayer having perpendicular magnetic anisotropy and a weakly magnetic underlayer stacked on the ferromagnetic underlayer, and a perpendicular magnetic recording layer formed on the weakly magnetic underlayer; and
a recording/reproducing head,
wherein the ferromagnetic underlayer has a perpendicular coercive force of not more than 39.5 kA/m (0.5 kOe), and the weakly magnetic underlayer has a saturation magnetization Ms of 50 to 150 emu/cc.

12. An apparatus according to claim 11, wherein the recording/reproducing head is a single pole recording head.

13. An apparatus according to claim 11, further comprising a soft magnetic backing layer between the nonmagnetic substrate and multilayered underlayer.

14. An apparatus according to claim 13, wherein the soft magnetic backing layer contains cobalt and at least one element selected from the group consisting of zirconium, hafnium, niobium, tantalum, titanium, and yttrium.

15. An apparatus according to claim 13, further comprising a cobalt-containing longitudinal hard magnetic layer between the nonmagnetic substrate and soft magnetic backing layer.

16. An apparatus according to claim 11, wherein the multilayered underlayer further includes an orientation control layer to control crystal orientation of the ferromagnetic underlayer, the orientation control layer being formed beneath the ferromagnetic underlayer, which faces the substrate, and having a fine crystal structure having an average grain size of not more than 3 nm.

17. An apparatus according to claim 16, wherein the orientation control layer contains at least one element selected from the group consisting of tantalum, niobium, cobalt, nickel, and carbon.

18. An apparatus according to claim 11, wherein the ferromagnetic underlayer has a saturation magnetization Ms of 300 to 1,000 emu/cc.

19. An apparatus according to claim 11, wherein the weakly magnetic underlayer has a thickness of 5 to 20 nm.

20. An apparatus according to claim 11, wherein the ferromagnetic underlayer has a thickness of 0.5 to 5 nm.

21. An apparatus according to claim 11, wherein at least one of the ferromagnetic underlayer, weakly magnetic underlayer, and perpendicular magnetic recording layer contains cobalt, chromium, and platinum.
